(19) United States
(12) Patent Application Publication
(10) Pub. No.: US 2018/0037287 A1
(43) Pub. Date: Feb. 8, 2018

(54) MOTORCYCLE RACK GAS CAN

(71) Applicant: Larooba, LLC, Farmington, UT (US)

(72) Inventor: Brent Allenbach, Farmington, UT (US)

(21) Appl. No.: 15/670,972

(22) Filed: Aug. 7, 2017

Related U.S. Application Data
(60) Provisional application No. 62/371,604, filed on Aug. 5, 2016.

(51) Int. Cl. B62J 35/00; B62D 61/02; B62J 7/02

(52) U.S. Cl. CPC B62J 35/00; B62J 7/02; B62D 61/02; B62J 7/00

(57) ABSTRACT

A gas can is configured to be secured to a rack of a motorcycle. The gas can have a generally flat profile so that the rack may still be used to transport luggage or other items even when the gas can is secured to it. The gas can may include a pair of opposing brackets that each have a J hook that can be secured underneath a bar of the rack. At least one of the brackets can include a sliding portion that can be slid to move the corresponding J hook thereby unlatching the J hook from the bar.

### CROSS-REFERENCE TO RELATED APPLICATIONS

This application claims the benefit of U.S. Provisional Patent Application No. 62/371,604 which was filed on Aug. 5, 2016.

### BACKGROUND

Motorcycles typically have relatively small gas tanks that may provide a couple hundred miles of travel per tank. Therefore, when travelling longer distances, there is oftentimes a risk that the motorcycle may run out of gas. As a result, many riders store a gas can in the saddle bag as an emergency source of gas. Doing so, however, results in the contents of the saddle bag taking on the smell of gas.

### BRIEF SUMMARY

The present invention extends to a gas can that is configured to be secured to a rack of a motorcycle. The gas can of the present invention may also have a generally flat profile so that the rack may still be used to transport luggage or other items even when the gas can is secured to it.

In some embodiments, the present invention is configured as a gas can that includes a container having generally flat top and bottom surfaces and a first bracket and a second bracket that are secured to the bottom surface at opposing sides. Each bracket includes a J hook that is configured to extend underneath a bar of a rack to secure the gas can to the rack. The first bracket includes a sliding portion that can be slid to reposition the corresponding J hook thereby allowing the gas can to be removed from the rack.

In other embodiments, the present invention is configured as a gas can that includes a container having top and bottom surfaces a first bracket and a second bracket that are secured to the bottom surface at opposing sides. Each bracket includes a bar securing component that is configured to extend underneath a bar of a rack to secure the gas can to the rack. The first bracket includes a sliding portion that can be slid to reposition the corresponding bar securing component thereby allowing the gas can to be removed from the rack.

In another embodiment, the present invention is implemented as a gas can that includes: a container having top and bottom surfaces and opposing sides that extend between the top and bottom surfaces, the bottom surface being substantially flat; and a first set of one or more brackets secured to one side and a second set of one or more brackets secured to the opposing side. Each bracket houses a pin of a latch that is configured to be secured to a handle of a motorcycle rack.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIG. 1 is a top perspective view of the gas can in accordance with one or more embodiments of the present invention;

FIG. 2 is a side view of the gas can of FIG. 1;

FIG. 3 is a bottom view of the gas can showing the securing mechanism in a closed position of FIG. 1;

FIG. 4 is a bottom view of the gas can showing the securing mechanism in an open position of FIG. 1;

FIG. 5 is a side view of the gas can when separated from the rack of FIG. 1;

FIG. 6 is an exploded view of the gas can of FIG. 1 in accordance with one or more embodiments of the present invention.

FIG. 7 illustrates a bottom view of another gas can in accordance with one or more embodiments of the present invention;

FIG. 8 illustrates a side view of the gas can of FIG. 7;

FIG. 9 illustrates a cross-sectional side view of the gas can of FIG. 7;

FIG. 10 illustrates a bracket that includes a sliding portion that can be employed on the gas can of FIG. 7 to allow the gas can to be selectively mounted to a rack;

FIG. 11 illustrates a recessed bottom surface of the gas can of FIG. 7 within which the bracket of FIG. 10 can mount;

FIGS. 12 and 13 illustrate cross-sectional views of the gas can of FIG. 7 when the bracket of FIG. 10 is in an extended and compressed position respectively;

FIGS. 14A and 14B also illustrate cross-sectional views of the gas can of FIG. 7 when the bracket of FIG. 10 is in an extended and compressed position respectively;

FIG. 15 illustrates a coupling plate that can be used with the gas can of FIG. 7 when the bars of the rack have an unconventional spacing;

FIG. 16 illustrates the coupling plate of FIG. 15 in isolation;

FIG. 17 illustrates a cross-sectional view of the gas can of FIG. 7 when coupled to a rack via the coupling plate of FIG. 15;

FIG. 18 illustrates how a J hook of a bracket can include a slot for receiving a tab of the coupling plate of FIG. 15;

FIG. 19A illustrates a version of the gas can of FIG. 7 that is configured for use on racks that have handles rather than bars;

FIG. 19B illustrates a bracket and butterfly latch that can be employed on the gas can of FIG. 19A;

FIG. 20 illustrates another bracket that can be employed on the gas can of FIG. 19A; and

FIG. 21 illustrates a plate that can be employed on the gas can of FIG. 19A.

### DETAILED DESCRIPTION

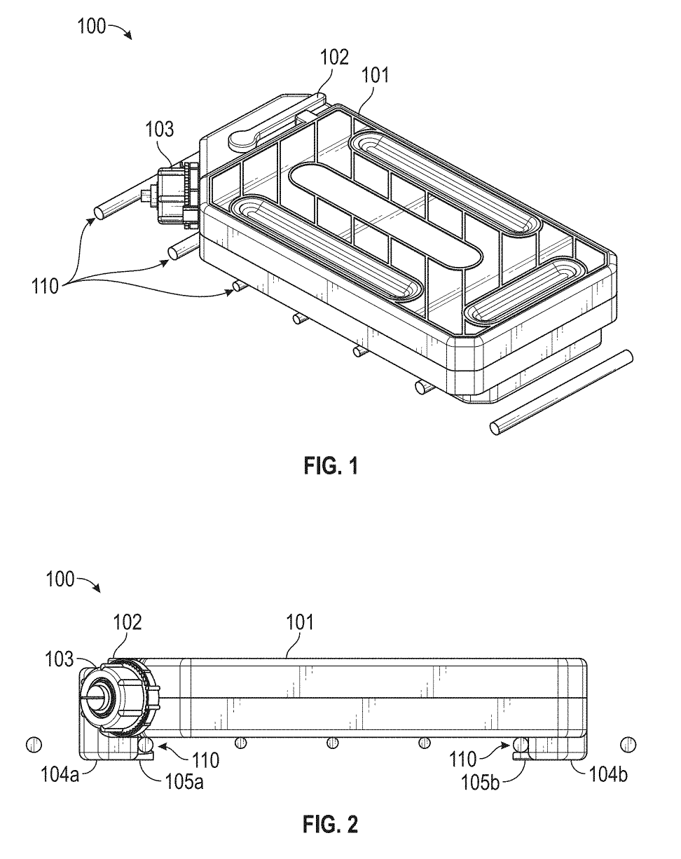

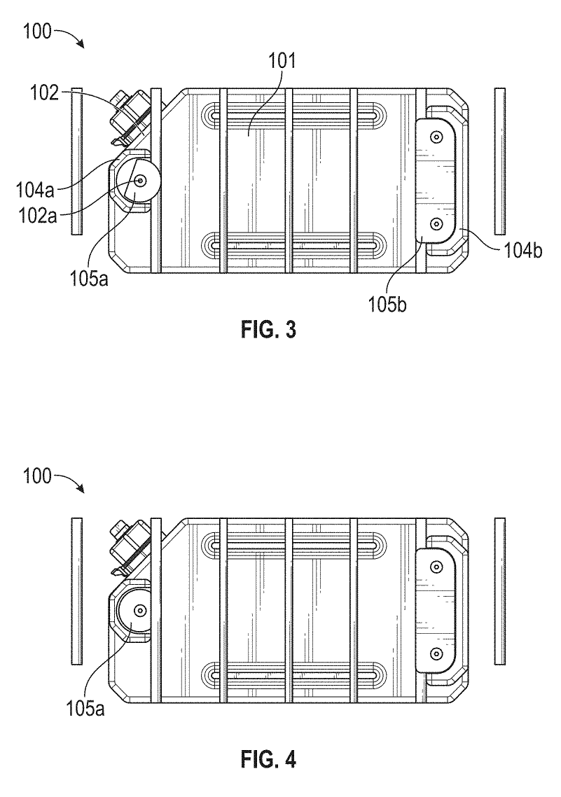

FIGS. 1-6 each depict a gas can 100 in accordance with one or more embodiments of the present invention. Gas can 100 comprises a hollow container 101 that has a generally flat top surface and that includes opposing protrusions 104a, 104b that extend from a bottom surface. As shown in FIG. 3, in some embodiments, protrusions 104a, 104b may only extend along a portion of the width of gas can 100. In some embodiments, one corner of gas can 100 may be angled to provide a surface for spout 103. Accordingly, gas can 100 can have a generally flat rectangular shape to allow it to be secured atop a motorcycle rack 110 while still providing a surface on which other items may be stacked.

Gas can 100 can include a securing mechanism which functions to secure the gas can to motorcycle rack 110. This securing mechanism can be formed by overhanging components 105a, 105b which extend inwardly from protrusions 104a, 104b respectively. As best shown in FIG. 2, because protrusions 104a, 104b extend downwardly from the bottom surface of gas can 100 and because overhanging components 105a, 105b extend inwardly from protrusions 104a, 104b, opposing channels are formed within which bars of rack 110 can be secured thereby securing gas can 100 to rack 110.

The distance between protrusions 104a, 104b can be configured to substantially correspond to the distance between two bars of rack 110. However, because different racks may employ different spacing between bars, in some embodiments, overhanging components 105a, 105b may have a greater length (i.e., they may extend further inward) than what is shown in the figures so that gas can 100 can be secured to a number of different racks that employ different bar spacing.

To allow gas can 100 to be secured to rack 110, overhanging component 105a may be repositionable. For example, in FIG. 4, overhanging component 105a is shown in an open position in which it does not extend inwardly beyond protrusion 104a. In contrast, FIG. 3 shows overhanging component 105a in the closed position in which it extends inwardly beyond protrusion 104a. Gas can 100 can include a lever 102 that is positioned at the top surface of the gas can and that functions to move overhanging component 105a between the open and closed position. Lever 102 can be coupled to overhanging component 105a in any suitable manner including via a screw or rod 102a.

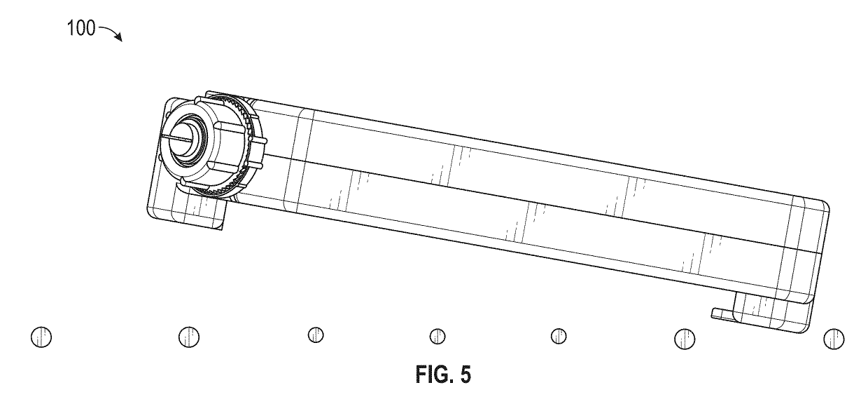

To secure gas can 100 to rack 110, overhanging component 105a can first be moved to the open position. With overhanging component 105a in the open position, overhanging component 105b can be hooked underneath a first bar of rack 110 and gas can 100 can be placed flat on top of the rack such that a second bar is positioned immediately inside protrusion 104a as is shown in FIG. 4. Then, lever 102 can be pivoted to cause overhanging component 105a to move into the closed position underneath the second bar as is shown in FIG. 3. These steps can be performed in reverse to remove gas can 100 from rack 110 as is represented in FIG. 5.

Lever 102 can be configured to lock in this closed position in any suitable manner. For example, a top surface of gas can 100 may include raised ridges which prevent lever 102 from opening without substantial force. In some embodiments, overhanging component 105a may also be configured to move from a downward to an upward position as it moves into the closed position. In other words, lever 102 can cause overhanging component 105a to be pulled upwardly against the second bar of rack 110 as it is closed. In this way, overhanging component 105a can be tightened against the rack.

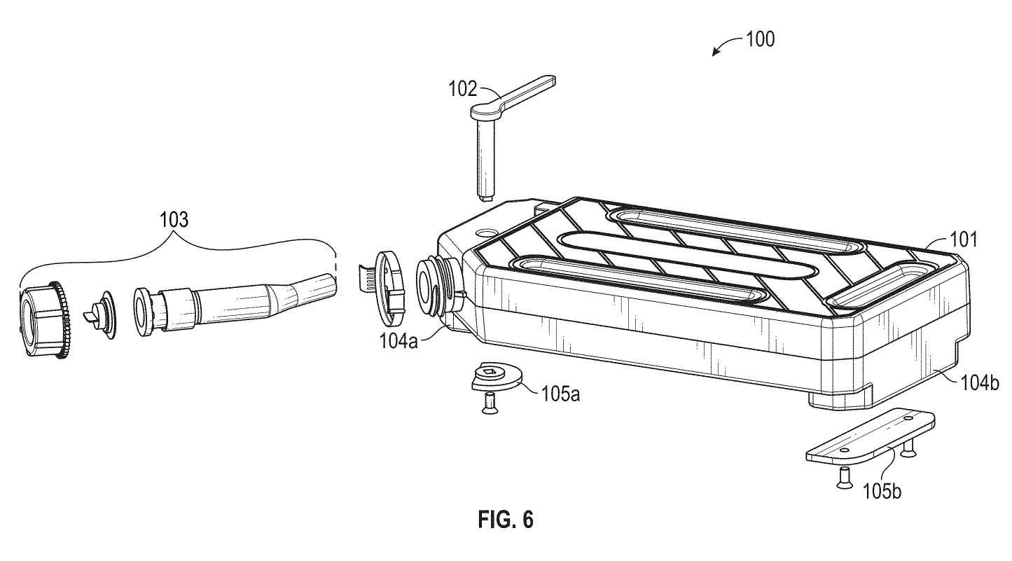

Although the figures depict overhanging component 105b as a separate component from container 101 (see, e.g., FIG. 6), in some embodiments, overhanging component 105b could be integrally molded with container 101. Also, although lever 102 and overhanging component 105a are configured to operate via a rotating motion, in some embodiments, lever 102 may be coupled in a manner that causes overhanging component 105a to pivot when lever 102 is moved in an upward or downward direction. Accordingly, lever 102 can be configured in any suitable manner which will allow it to pivot overhanging component 105a from the open to the closed position.

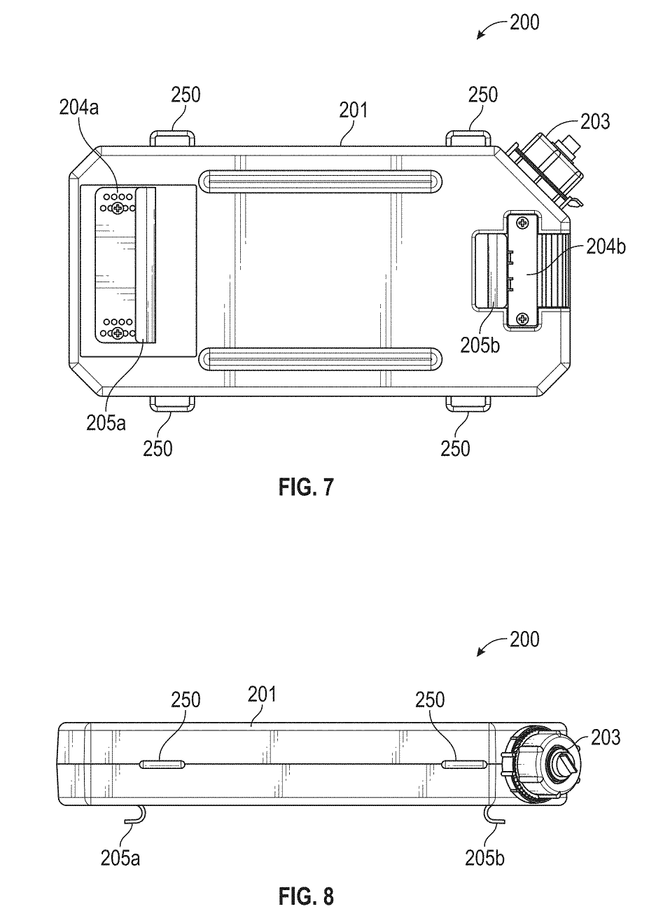

FIGS. 7-14B illustrate another gas can 200 that is configured in accordance with one or more embodiments of the present invention. Gas can 200 is substantially similar to gas can 100 except that gas can 200 employs a different securing mechanism for securing gas can 200 to rack 110. For example, as shown in FIGS. 7 and 8, gas can 200 includes a container 201 that is generally flat and a spout 203. However, the securing mechanism employed on gas can 200 is comprised of brackets 204a and 204b which each include an outwardly facing J hook 205a and 205b respectively. Although J hooks are shown in the figures, the “bar securing component” of the bracket could be another similarly structured component that can extend around a bar of a rack to secure the gas can to the rack.

As shown in FIG. 7, bracket 204a can include a number of mounting holes to allow the relative position of bracket 204a to be adjusted to thereby accommodate differently sized/spaced racks. Alternatively, a lengthened mounting slot could be employed for the same purpose. Although not shown, bracket 204b could also include similar mounting holes or lengthened mounting slots to allow the relative position of bracket 204b to also be adjusted. In other words, brackets 204a and 204b can be repositionable to customize the space between J hooks 205a and 205b for a particular rack.

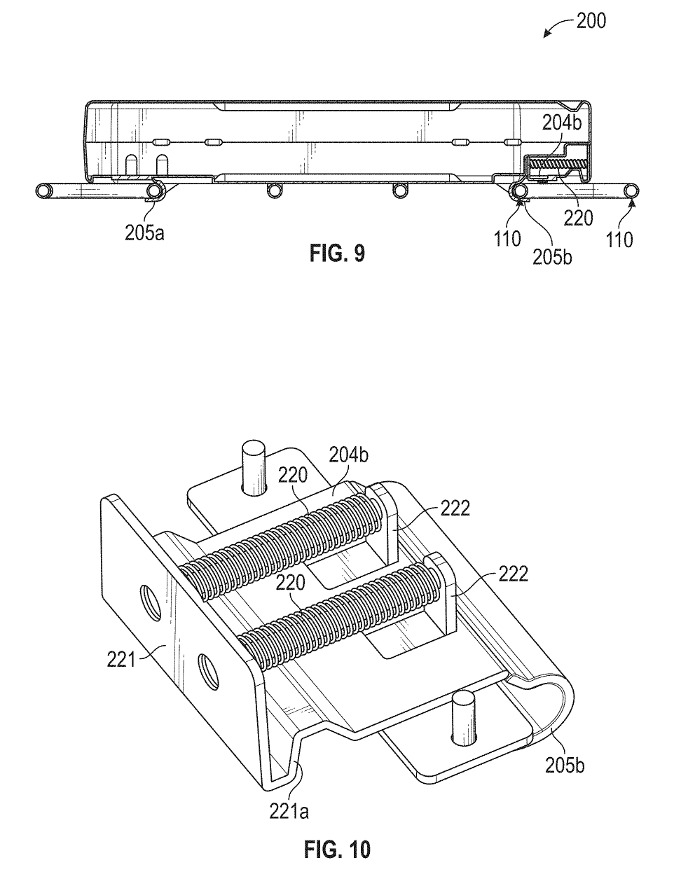

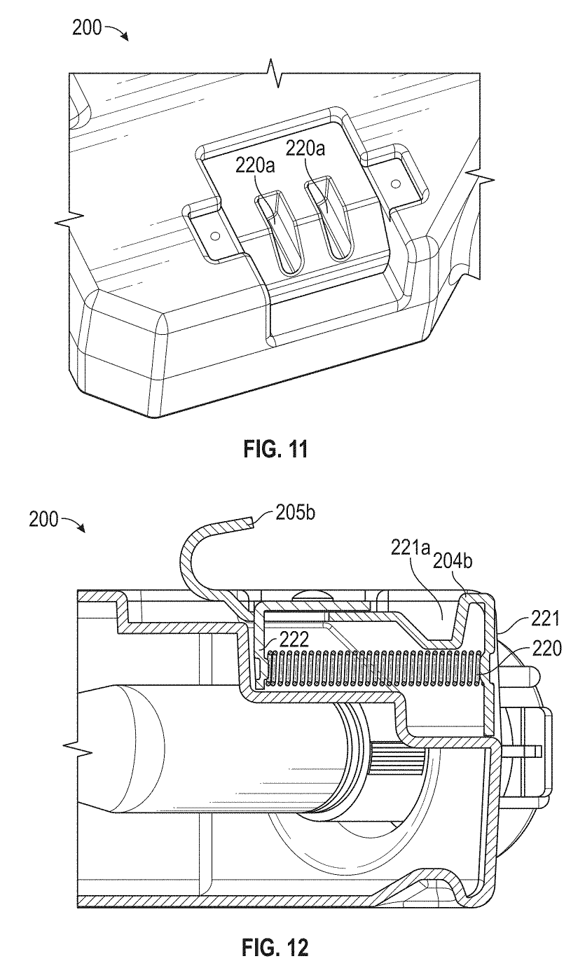

FIG. 9 illustrates a cross-sectional view of gas can 200 when mounted to rack 110. As shown, J hooks 205a and 205b can extend underneath different bars of rack 110 to secure gas can 200 to rack 110. To attach and release gas can 200 from rack 110, a portion of bracket 204b (i.e., the portion that includes J hook 205b) can be configured to slide inwardly along container 201. FIGS. 10 and 11 illustrate one example configuration of bracket 204b and the corresponding underside of container 201 within which bracket 204b is mounted.

Bracket 204b can include a sliding portion 221 that is biased in an extended position by one or more springs 220. Sliding portion 221 can include extensions 222 for forming a surface against which springs 220 can be biased when sliding portion 221 is slid inwardly. The underside of container 201 can be recessed to accommodate brackets 204a and 204b and the recessed portion corresponding to bracket 204b can include slots 220a into which extensions 222 and springs 220 can insert when bracket 204b is mounted to container 201. By recessing the underside of container 201, the securing mechanism can be incorporated into container 201 while still allowing container 201 to lie flat on rack 110. This recess can also reinforce bracket 204b to minimize the likelihood that sliding portion 221 may become separated from bracket 204b. Sliding portion 221 can include an indentation 221a which can facilitate gripping sliding portion 221.

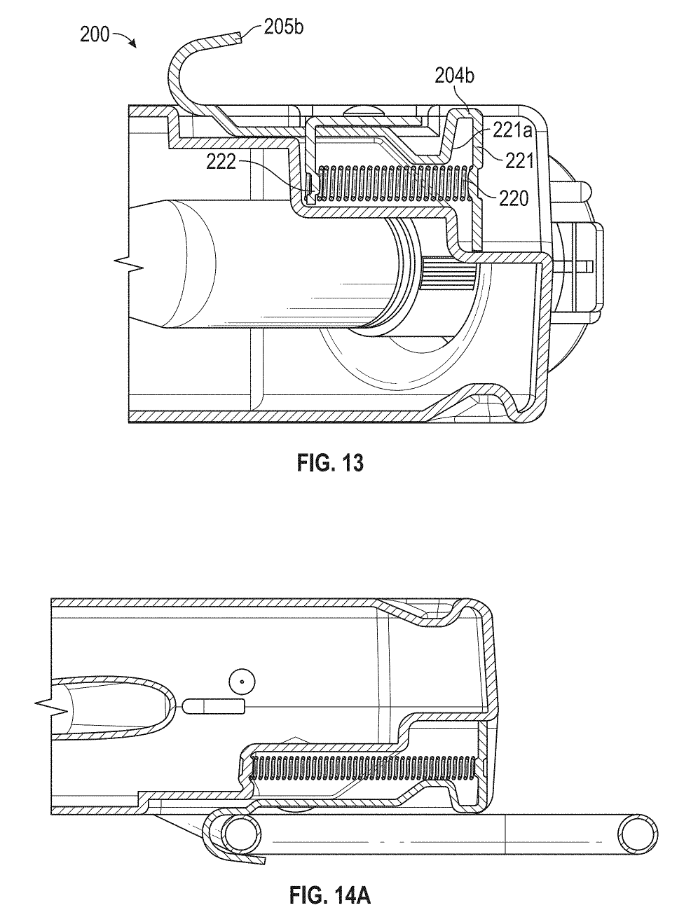

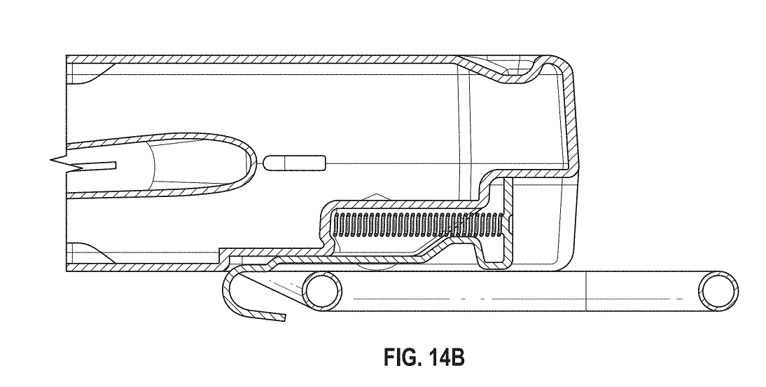

FIG. 12 illustrates a cross-sectional view of bracket 204b when mounted to container 201 and when in the extended position. In contrast, FIG. 13 illustrates a cross-sectional view of bracket 204b when mounted to container 201 and when in the compressed (or unlatched) position. Springs 220 can bias sliding portion 221 into the extended position so that J hook 205b is maintained underneath (and therefore secured to) a bar of rack 110 such as is shown in FIG. 14A. Then, to unlatch J hook 205b from the bar, sliding portion 221 can be slid inwardly into the position shown in FIG. 13. This inward sliding will in turn move J hook 205b beyond the bar of rack 110 such as is shown in FIG. 14B thereby allowing gas can 200 to be lifted away from rack 110. Therefore, bracket 204b allows gas can 200 to be quickly and easily removed from rack 110. In some embodiments, J hooks 205a and 205b can be rubber coated to enhance their grip on rack 110. Although only bracket 204b is shown as including a sliding portion 221, in some embodiments, both brackets 204a and 204b may include sliding portions to allow either or both J hooks to be slid inwardly to remove the gas can from the rack.

Containers 101 and 201 can be configured with any desired size. However, in preferred embodiments, the length and width of containers 101 and 201 can be selected such that a portion of the bars of rack 110 remain exposed around the perimeter of the container. This would allow the portion of the bars to remain accessible for securing other items to the rack which may be stacked on top of gas can 100 or 200. As indicated above, due to its flat profile, the use of gas can 100 or 200 will not greatly minimize the ability to secure additional items to rack 110. Alternatively or additionally, container 101 or 201 could include hooks that protrude from the sides of the container. For example, container 201 is shown as including four hooks 250. Hooks 250 can be employed to secure other items to rack 110 when gas can 200 is also secured to rack 110. Although not shown, gas can 100 could include similar hooks.

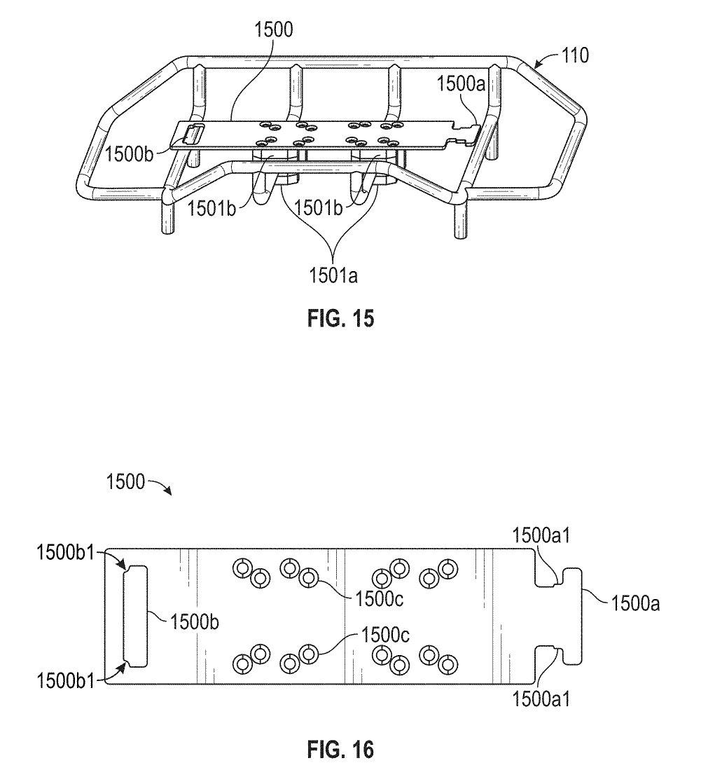

With some racks, the spacing between bars and/or the size of the rack may prevent gas can 200 from being coupled to the rack. To address such cases, the present invention may include a coupling plate that mounts to the rack and functions as an interface for coupling gas can 200 to the rack. FIGS. 15-17 illustrate an embodiment of a coupling plate 1500 that can function in this manner.

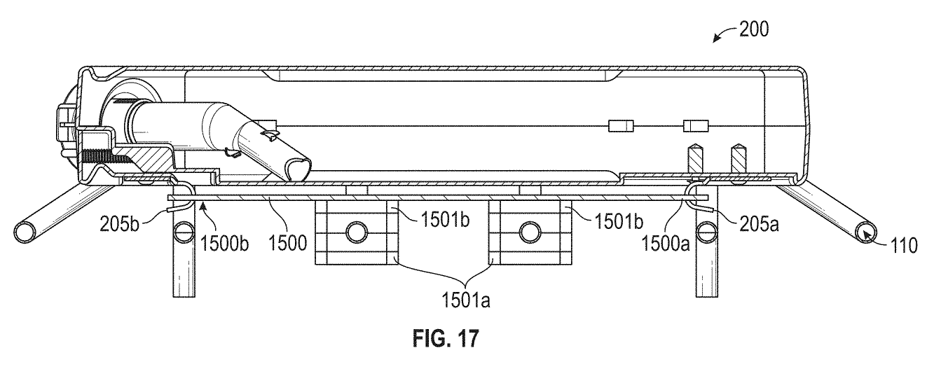

In FIG. 15, coupling plate 1500 is coupled to rack 110 via pairs of coupling components 1501a, 1501b. Coupling component 1501b can be positioned above a bar of rack 110 while coupling component 1501a can be positioned below the bar in alignment with coupling component 1501b. Multiple pairs (e.g., four) of coupling components 1501a, 1501b can be employed and spaced apart to provide a surface on which coupling plate 1500 may rest. As shown in FIG. 16, coupling plate 1500 can include a number of holes 1500c in various patterns which will allow coupling plate 1500 to be coupled to racks with various different bar spacings and orientations. In addition to securing coupling plate 1500 to rack 110, coupling component 1501b can also function as a spacer to elevate coupling plate 1500 away from the bars of rack 110. For example, FIG. 17 shows that coupling component 1501b causes J hooks 205a, 205b to be positioned above (and to therefore not interfere with) the bars of rack 110 when secured to coupling plate 1500.

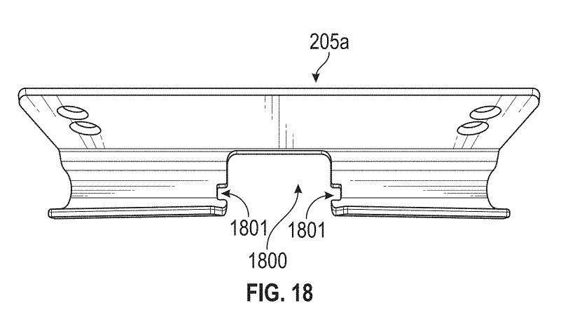

As best seen in FIG. 16, coupling plate 1500 includes a channel 1500b at one end and a tab 1500a at the opposing end. The spacing between channel 1500b and tab 1500a can correspond with the spacing between J hooks 205a, 205b to thereby allow gas can 200 to be secured to coupling plate 1500. It is noted that coupling plate 1500 could alternatively be configured with a second channel, similar to channel 1500b, in place of tab 1500a. In cases where tab 1500a is used, J hook 205a can be modified to include a slot 1800 as is shown in FIG. 18. To secure gas can 200 to coupling plate 1500, tab 1500a can first be inserted through slot 1800 to position the outer ends of tab 1500a inside J hook 205a such as is shown in FIG. 17. Then, J hook 205b can be slid backwards until it inserts through channel 1500b. The biasing force of springs 220 will then retain J hooks 205a, 205b in this interlocked configuration with coupling plate 1500.

One benefit of employing tab 1500a rather than a second channel is that it allows J hook 205a to be relatively wide without requiring coupling plate 1500 to be wider than J hook 205a. The additional width of J hook 205a can enhance the stability of the coupling between gas can 200 and rack 110. This stability can be further enhanced in some embodiments by including notches on the sides of J hooks 205a, 205b. For example, in FIG. 18, J hook 205a includes opposing notches 1801 within slot 1800. Notches 1801 align with protrusions 1500a1 on the neck of tab 1500a. When tab 1500a is contained within J hook 205a, protrusions 1500a1 will be contained within notches 1801. The bottom and top surfaces of protrusions 1500a1 will contact the corresponding surfaces of notches 1801 to limit the side-to-side rocking of gas can 200. Although not shown, J hook 205b can include similar notches (albeit on its outer surfaces) that interface in a similar manner with protrusions 1500b1.

In addition to the depicted embodiment where coupling plate 1500 is a single component, in other embodiments, coupling plate 1500 could be formed of two separate pieces. For example, coupling plate 1500 could be split down the middle so that channel 1500b is formed in one piece and tab 1500a is formed on another piece. Configuring coupling plate 1500 as two separate pieces can enable coupling plate 1500 to be used on an even wider variety of rack shapes and sizes.

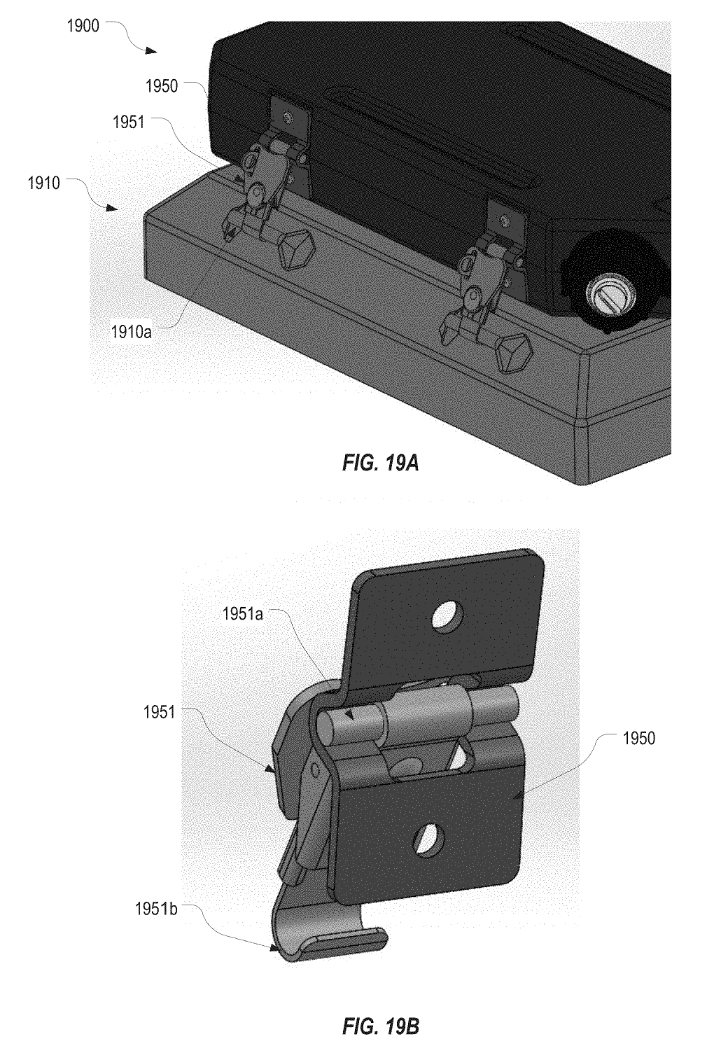

FIG. 19A illustrates another embodiment of a gas can 1900 that is substantially similar to gas can 200. Although not visible, gas can 1900 could be configured for brackets 204a and 204b but may not include them if desired. Unlike gas can 200, gas can 1900 includes brackets 1950 which are adapted to house a pin 1951a of a butterfly latch 1951. The body of butterfly latch 1951 can therefore pivot around pin 1951a. An opposing end of butterfly latch 1951 can form a hook 1951b that may insert under a handle 1910a of a rack 1910. Rack 1910 is an example of a type of rack that is oftentimes employed on BMW motorcycles. Accordingly, FIG. 19A represents one way in which gas can 200 can be adapted for use on such BMW motorcycles.

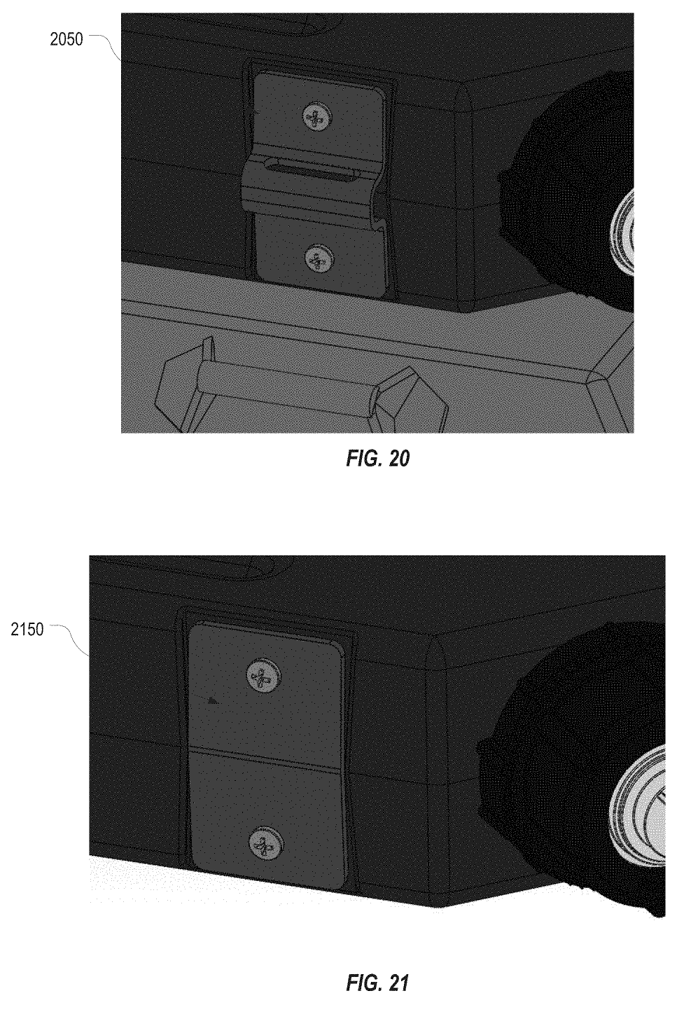

Because brackets 1950 serve as the primary connection point for mounting gas can 1900 to rack 1910, brackets 1950 can be configured to extend across the full height of the side of gas can 1900 and can be coupled (e.g., via screws) at both the top and bottom of the bracket. Accordingly, gas can 1900 can be molded to include top and bottom mounting holes for coupling bracket 1950 to gas can 1900. FIGS. 20 and 21 illustrate alternative brackets 2050, 2150 respectively that could be used in place of brackets 1950. Bracket 2050 includes a slot that could be used to tie down gas can 1900 to handle 1910a. In contrast, bracket 2150 forms a flat surface and can be employed when gas can 1900 will be secured via brackets 204a, 204b. Another benefit of brackets 1950, 2050, and 2150 is that they provide reinforcement to gas can 1900 which may be molded as top and bottom pieces.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A gas can comprising:
a container having generally flat top and bottom surfaces; and
a first bracket and a second bracket that are secured to the bottom surface at opposing sides, each bracket including a J hook that is configured to extend underneath a bar of a rack to secure the gas can to the rack;
wherein the first bracket includes a sliding portion that can be slid to reposition the corresponding J hook thereby allowing the gas can to be removed from the rack.

2. The gas can of claim 1, wherein the sliding portion is biased by one or more springs to prevent the sliding portion from being slid.

3. The gas can of claim 2, wherein the sliding portion includes one or more extensions that form a surface against which the one or more springs are biased.

4. The gas can of claim 1, wherein the J hooks are oriented outwardly.

5. The gas can of claim 1, wherein the J hooks are oriented in opposite directions.

6. The gas can of claim 1, wherein the bottom surface of the container is recessed and the brackets are secured within the recesses.

7. The gas can of claim 1, wherein the container includes one or more hooks that extend from one or more sides.

8. The gas can of claim 1, wherein the bottom surface of the container or one or more of the brackets are configured to allow the brackets to be coupled to the container at multiple spacings.

9. The gas can of claim 1, wherein the sliding portion includes an indentation that is oriented downwardly.

10. The gas can of claim 1, further comprising:
a coupling plate configured to be coupled to the rack;
wherein the coupling plate is configured to receive the J hooks to thereby secure the gas can to the coupling plate when the coupling plate is coupled to the rack.

11. The gas can of claim 10, wherein the coupling plate includes a channel at a first end, the channel configured to receive the J hook of the first bracket.

12. The gas can of claim 11, wherein the coupling plate further includes a tab at a second end opposite the first end, the tab being configured to insert into a slot in the J hook of the second bracket.

13. The gas can of claim 11, wherein the coupling plate further includes a second channel at a second end opposite the first end, the second channel configured to receive the J hook of the second bracket.

14. The gas can of claim 11, wherein the J hook of the first bracket includes one or more notches and the channel includes one or more protrusions that insert into the one or more notches.

15. The gas can of claim 12, wherein the J hook of the second bracket includes one or more notches and the tab includes one or more protrusions that insert into the one or more notches.

16. The gas can of claim 10, further comprising:
coupling components that are configured to secure the coupling plate to the rack, the coupling components spacing the coupling plate above bars of the rack to prevent the J hooks from contacting the bars when the J hooks are coupled to the coupling plate.

17. The gas can of claim 10, wherein the coupling plate comprises a first piece that includes a channel configured to receive the J hook of the first bracket and a second piece that includes a tab configured to insert into a slot in the J hook of the second bracket.

18. The gas can of claim 10, wherein the coupling plate includes multiple hole patterns for coupling the coupling plate to multiple different racks with different spacing between bars.

19. A gas can comprising:
a container having top and bottom surfaces; and
a first bracket and a second bracket that are secured to the bottom surface at opposing sides, each bracket including a bar securing component that is configured to extend underneath a bar of a rack to secure the gas can to the rack;
wherein the first bracket includes a sliding portion that can be slid to reposition the corresponding bar securing component thereby allowing the gas can to be removed from the rack.

20. A gas can comprising:
a container having top and bottom surfaces and opposing sides that extend between the top and bottom surfaces, the bottom surface being substantially flat; and
a first set of one or more brackets secured to one side and a second set of one or more brackets secured to the opposing side, each bracket housing a pin of a latch that is configured to be secured to a handle of a motorcycle rack.
